(19) United States
(12) Patent Application Publication
(10) Pub. No.: US 2026/0370505 A1
(43) Pub. Date: Nov. 19, 2026

(54) FREQUENCY INTERLEAVER DESIGN FOR BROADCAST OR MULTICAST

(71) Applicant: QUALCOMM Incorporated, San Diego, CA (US)

(72) Inventors: Javier RODRIGUEZ FERNANDEZ, San Diego, CA (US); Ayan SENGUPTA, Mountain View, CA (US); Alberto RICO ALVARINO, San Diego, CA (US)

(21) Appl. No.: 19/668,643

(22) Filed: May 5, 2026

Related U.S. Application Data
(60) Provisional application No. 63/803,319, filed on May 9, 2025.

(51) Int. Cl. H04L 12/18; H04L 1/00

(52) U.S. Cl. CPC H04L 12/1877; H04L 1/0071

(57) ABSTRACT

Certain aspects of the present disclosure provide techniques for wireless communications. An example method includes receiving, in a set of time intervals, a broadcast or multicast transmission of a transport block, the transport block comprising a plurality of code blocks (CBs), wherein portions of the plurality of CBs are interleaved in the set of time intervals according to an interleaving configuration that is associated with at least one of: a number of CBs in the plurality of CBs, a numerology of the broadcast or multicast transmission, a transport block size of the transport block, a symbol index associated with the set of time intervals, or a modulation and coding scheme of the broadcast or multicast transmission; performing deinterleaving of the portions of the plurality of CBs to obtain the plurality of CBs; and decoding the plurality of CBs.

### CROSS-REFERENCE TO RELATED APPLICATION(S)

The present Application for Patent claims benefit of U.S. Provisional Application No. 63/803,319, filed May 9, 2025, which is hereby expressly incorporated by reference herein in its entirety.

### INTRODUCTION

### Field of the Disclosure

Aspects of the present disclosure relate to wireless communications, and more particularly, to techniques for frequency interleaver design for broadcast or multicast.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

A radio access technology (RAT) may support multicast communication. In multicast communication, information is simultaneously transmitted from one source to multiple selected recipients. Multicast may reduce overhead relative to unicast communication, since unicast communication involves individual connections between a sender and each recipient, whereas multicast involves a single data stream that is replicated to the multiple recipients. Broadcast communication represents a form of multicast wherein data is transmitted from a single source to all possible recipients within an area, group of recipients, or the like. Both multicast and broadcast methodologies are particularly advantageous for applications requiring identical content delivery to multiple recipients, such as media streaming, software distribution, and real-time information dissemination.

Some RATs may support Multimedia Broadcast Single Frequency Network (MBSFN) deployments. In MBSFN, multiple network entities may synchronously transmit identical signals using the same frequency resources, thereby creating a single-frequency network (SFN). In an MBSFN implementation, participating transmission points are temporally and spectrally synchronized to transmit identical content with precise timing alignment. This synchronization creates constructive signal contributions, thereby enhancing reception quality at user equipment locations, particularly near cell boundaries. MBSFN transmissions may be organized into MBSFN areas, wherein all transmission points within a designated geographical region participate in the synchronized transmission.

Broadcast communications may not use retransmission schemes such as hybrid automatic repeat request (HARQ) or automatic repeat request (ARQ). Therefore, it is desirable for broadcast implementations to operate at a low block error rate (BLER). BLER can be improved through the use of various forms of diversity. In some cases, such as low-band broadcast (where a single transmit antenna may be used and any receive antennas may be correlated with one another), time diversity and frequency diversity can improve BLER.

One way to implement frequency diversity is the use of frequency interleaving. In the context of code block transmission, frequency interleaving involves the rearrangement of frequency-domain elements of a transmission, such as subcarriers, such that adjacent (in the frequency domain) elements are associated with (e.g., derived from) different code blocks. Frequency interleaving can be achieved by inputting, into an interleaving matrix, elements (e.g., tones) of the (multiple) codeblocks and/or parts of codeblocks that are transmitted within the OFDM symbol that is to be frequency interleaved, where the inputting of the multiple elements of the multiple codeblocks and/or parts of codeblocks into the interleaving matrix is performed in a column-wise fashion (e.g., fill a first column, then a second column, and so on), and then outputting the elements in a row-wise fashion (e.g., read the elements from a first row, then a second row, and so on). In this fashion, impact of subcarrier-specific channel conditions is reduced.

A transport block, such as a transport block being transmitted via a multicast or broadcast transmission, may include a plurality of code blocks (CBs). A transport block is a data unit that is provided to the physical layer for transmission. If the transport block exceeds a threshold size, the transport block is split into a plurality of code blocks (CBs). Each CB may have a cyclic redundancy check, and these CBs in some examples may be channel coded individually.

Frequency diversity may be implemented for a plurality of CBs using a frequency interleaver. A goal of the frequency interleaver is to protect the different (systematic) bits of each CB that are transmitted over the different symbols, one symbol at a time. A symbol, in this context, may be an orthogonal frequency division multiplexing (OFDM) symbol, which is associated with a time interval defined according to a subcarrier spacing for the corresponding numerology (e.g., 1.25 kHz, 2.5 kHz, etc.). In general, for a transport block comprising N_{CB} CBs to be transmitted over N_{symb} OFDM symbols, the number of CBs that a symbol can carry is N_{CB}/N_{symb}. For example for the a 200/800 numerology (e.g., with an 800 microsecond time unit and a 200 microsecond cyclic prefix), which uses a transport-block-per-subframe mapping (which is equivalent to a transport-block-per-symbol mapping), each symbol carries all the CBs of the transport block. For a 100/400 numerology with a transport block with 4 CBs mapped over 2 symbols in a subframe, the number of CBs each symbol carries is 2. For example, a first symbol of a first subframe may include CB1 and CB2 of TB1, a second symbol of a first subframe may include CB3 and CB4 of TB1, a first symbol of a second subframe may include CB1 and CB2 of TB2, a second symbol of a second subframe may include CB3 and CB4 of TB2, a first symbol of a third subframe may include CB1 and CB2 of TB3, and a second symbol of a third subframe may include CB3 and CB4 of TB3.

There are other techniques which can also improve the BLER of a multicast or broadcast transmission in combination with frequency interleaving, such as performing element rearrangement (e.g., row permutation, column permutation, or cyclic shifting) of rows or columns of the interleaving matrix. However, these operations may be ineffective if applied in an indiscriminate fashion. For example, if a column of the interleaving matrix includes elements of multiple different code blocks, these techniques may fail to provide improved performance or may even cause failure of the broadcast or multicast transmission. Furthermore, different code blocks may be of different sizes, and different numbers of code blocks may be mappable to symbols in some cases, which leads to complexity in how code blocks are mapped into interleaving matrices.

Aspects of the present disclosure provide techniques for configuring an interleaving configuration (such as an interleaving matrix), or element rearrangement of an interleaving matrix, to improve BLER, particularly for broadcast or multicast transmissions. These techniques may be applicable for broadcast or multicast transmission of a TB carrying a plurality of CBs as described below. This TB may be transmitted on (e.g., interleaved over) a set of time intervals, such as a set of OFDM symbols and/or a set of subframes.

For example, some aspects provide for determination of an interleaving configuration such that each column in an interleaving matrix of the interleaving configuration only (or predominately) contains tones corresponding to a single CB, without mixing multiple CBs in any column. For example, a number of columns of the interleaving matrix may be derived from one or more parameters such that the columns only (or predominately) contain tones corresponding to a single CB, or contain higher than a threshold number or ratio of tones associated with a single CB. The one or more parameters may include any combination of, for example, a number of CBs (denoted N_{CB}) in the plurality of CBs, a numerology of the broadcast or multicast transmission (for example, an OFDM numerology, which may indicate any combination of a subcarrier spacing, a cyclic prefix, or a number of OFDM symbols over which the TB is transmitted), a transport block size of the transport block (e.g., a number of bits in the transport block), a symbol index (e.g., OFDM symbol index) associated with the set of time intervals (e.g., of a current OFDM symbol that is to be frequency interleaved), a number of OFDM symbols over which the TB is to be interleaved or transmitted (denoted N_{symb}) or a modulation and coding scheme of the broadcast or multicast transmission. A modulation and coding scheme is a parameter that indicates a modulation order and a code rate of a communication, such as according to a table in a wireless communication specification.

For example, in some aspects, the number of columns, C, of a frequency interleaving matrix may be designed such that, after writing a (zero-padded) modulation symbol vector column-wise into an interleaving matrix, each column in the interleaving matrix contains only (or predominately) tones corresponding to a single CB. In some aspects, the number of columns, C, may be determined according to Formula 1:

$$C = \frac{{N}_{CB}}{gcd ( {N}_{CB} , {N}_{symb} )} \qquad ( 1 )$$

Here, “gcd” indicates a greatest common divisor operation. As another example, the number of columns, C, may be determined according to Formula 2:

$$C = \frac{{N}_{CB}}{gcd ( {N}_{CB} , {N}_{symb} )} \cdot k \qquad ( 2 )$$

Here, k is an integer that is based at least in part on any combination of the one or more parameters described above. In some aspects, C and/or k may be signaled to a UE. In some aspects, C and/or k may be determined by the UE. Thus, the interleaving matrix may (modulo spillover) contain (potentially different parts of) a single CB in each row, and any subsequent element rearrangements (e.g., row and/or column permutations and/or cyclic shifts) can operate on each CB independently and, for the same tone index(es) across CBs, on every CB.

In some aspects (which can be implemented in addition to or as an alternative to the aspects described above for the determination of the number of columns C), element rearrangements may be applied to each row or column (where “row or column” can refer to a row, or a column, of a matrix) of the interleaving matrix in an independent (e.g., row-specific, column-specific, isolated to a single row, isolated to a single column, isolated to columns associated with a single CB, or the like) manner. Here, the element rearrangement may be based on a set of parameters, including any one or more of a number of CBs in the plurality of CBs, a numerology of the broadcast or multicast transmission, a number of columns in the interleaving matrix, a symbol index associated with the set of time intervals, a multicast radio network temporary identifier of the broadcast or multicast transmission, a multicast/broadcast single frequency network (MBSFN) area identity associated with the UE, or a slot number of the set of time intervals. Notably, basing the element rearrangement on one or more of the multicast radio network temporary identifier, the MBSFN area identity, or the slot number allows an element of randomization to be applied to the element rearrangement. As mentioned, some examples of the element rearrangement include a cyclic shift, a row permutation, or a column permutation. Thus, each row may be appropriately permuted and/or cyclically shifted to perform intra-CB-level interleaving specifically tailored for the OFDM numerology, the number of CBs in the TB, or the like. Furthermore, any column of the interleaving matrix may be appropriately permuted and/or cyclically shifted in order to combat any potential pathology in the fading channel affecting the current OFDM symbol, especially in the event of any CB being written into more than a single column in the interleaving matrix.

Interleaving can be performed with different numbers of CBs per TB. Notably, these illustrations may be illustrations of interleaving matrices for given symbols, such that the vertical rectangles of these illustrations represent columns of the interleaving matrices. Referring to Example 1 (which illustrates a co-prime number of CBs and symbols) to explain terminology, with 2 OFDM symbols per TB and 5 CBs per TB, C may be determined as

$$C = \frac{5}{gcd ( 5 , 2 )} = 5 columns .$$

In Symbol #1, a first part of CB1, a second part of CB1, a first part of CB2, a second part of CB2, and a first part of CB3 are interleaved. In Symbol #2, a second part of CB3, a first part of CB4, a second part of CB4, a first part of CB5, and a second part of CB5 are interleaved. Similar notation is used for other illustrations of interleaving matrices in the Appendix.

In general, for a number of CBs denoted N_{CB}, one of three cases can occur: Case 1, in which the interleaving matrix can accommodate an integer number of CBs and thus the number of columns each CB spans is identical; Case 2, in which the interleaving matrix can accommodate a fractional number of CBs and in the first OFDM symbol there are two different numbers of columns that a CB may span, across CBs; and Case 3, which may be similar to Case 2, but for OFDM symbols that are not the first symbol, there may be a number of columns for the CB that spilled over from the previous symbol, a number of columns for a number of integer CBs that the interleaving matrix can accommodate, and a third number of columns for a last CB that will spill over to the next symbol (this is only applicable to 7.5 and 15 kHz numerology, in which the number of symbols is greater than 2). Thus, when gcd (N_{CB}, N_{symb})=1 and k=1 as described above, C=N_{CB} and the number of parts per CB will be equal to N_{symb}, otherwise, the number of parts per CB will be C/(N_{CB}N_{symb}) due to each column containing N_{CB}/C more parts of a CB due to greatest-common-divisor downscaling of the number of columns. For Case 2, the maximum number of columns a CB may span is N_{symb}. For Case 3, in the first symbol this number is 6 for 2 CBs, in the second we have max(5,6,2)=6.

In some aspects, in accordance with an interleaving configuration, a network entity or UE may permute column indexes prior to applying row-specific element rearrangements (such as row-specific cyclic shifts) such that, after an output of the interleaving matrix is obtained in a row-wise fashion, tones belonging to a given CB are not written consecutively into the OFDM symbol, and this may hold for every CB of the plurality of CBs.

For example, after performing a first element rearrangement (e.g., a row permutation or a column permutation), and before performing a third element rearrangement (e.g., a row-specific cyclic shift or a column-specific cyclic shift, which may be different across different rows or columns), for a set of CBs mapped to a given OFDM symbol (e.g., time interval), if the i^{th} CB (e.g., a given CB) in the set of CBs is mapped to kᵢ distinct columns in the interleaving matrix (kᵢ is distinct from k described above),

$$i = 1 , … , ⌈ \frac{{N}_{CB}}{{N}_{symb}} ⌉ ,$$

a second element rearrangement comprising a common column (or row) permutation may be applied to obtain the column indexes c′=π(c), c=1, . . . , C, as shown below:

$$α = gcd ( {max}_{i} ( {k}_{i} ) , C )$$

$${c}^{′} = π ( c ) = m \cdot max ( {k}_{i} ) + mod ( n , C )$$

### Here,

$$m = 0 , 1 , … , \frac{C}{α} - 1$$

and n=0,1, . . . , α−1, where the order of iteration may be first m, second n or vice versa. Furthermore,

c=mα+n+1

or

$$c = \frac{nc}{α} + m + 1$$

When α=gcd (max(kᵢ),C)=1, π(c) will generate [symbol] ={0, . . . , C−1} due to max(kᵢ) and C being coprime. For α>1, sweeping over n=0, . . . , a−1 ensures that the union of the sets [symbol] ₙ generated by each n will generate [symbol] above due to π(c) being used to generate “shifted” versions of [symbol] ₙ that are mutually disjoint with one another. These techniques can be applied in connection with any other technique or aspect described herein. In some aspects, the UE and/or the network entity may determine kᵢ. For example, the UE and/or the network entity may determine kᵢ using any one or more parameters described herein, such as the number of CBs, the number of symbols, the number of columns (C), and the OFDM symbol index within the set of symbols over which the TB containing the plurality of CBs will be mapped. In some aspects, the UE may receive information indicating kᵢ. Thus, the network entity and/or UE may perform a first element rearrangement comprising a first permutation of first elements in a column, where the first permutation for any particular first element in the column is the same across each column of the columns, thereby resulting in a common row permutation for each column, in the interleaving matrix, that conforms to a first target permutation, a second element rearrangement comprising a second permutation of second elements in a row, where the second permutation of any particular second element in the row is the same across each row of the rows, thereby resulting in a common column permutation for each row, in the interleaving matrix, that conforms to a second target permutation, and a third element rearrangement comprising a row-specific cyclic shift.

In some aspects, after performing element rearrangement as described above, another element rearrangement may be applied. This other element rearrangement may be based on one or more of an OFDM numerology, the value of α defined above, value(s) of kᵢ, a number of columns (C) of the interleaving matrix, a number of CBs in the interleaving matrix, or a combination thereof. In some aspects, the other element rearrangement may be common across rows (or common across columns), such that a same element rearrangement is applied to each row (or column). In some other aspects, the other element rearrangement may be row-specific (or column-specific), where an element rearrangement to be applied at a particular row or column (row/column) may be based on at least one of a row/column index of the particular row/column, a cyclic shift for the particular row/column, an OFDM symbol index in a subframe over which a TB from which the number of CBs is derived is mapped, or a combination thereof.

In some aspects, an element rearrangement comprising a column permutation may be denoted c′=π(c) (which may be different than π(i) described below). Let c′=π(c) be a column permutation as described in slide 11. Also, let σⱼ denote the elements in c′, c′ (m), that fulfill mod

$$( {c}^{′} ( m ) , {max}_{i} ( {k}_{i} ) ) = j , j = 0 , … , {max}_{i} ( {k}_{i} ) - 1 ,$$

m=0, . . . Mⱼ−1, for a certain Mⱼ. Taking the maximum of kᵢ ensures that two consecutive columns of the same CB are not placed together. Even numbered columns are mapped to σ₀, and odd-numbered columns are mapped to σ₁. Mⱼ may be based on one or more of the number of columns, number of CBs, or current OFDM symbol index. Each set of elements σⱼ, for each j, may be further permuted with a permutation sequence obtained from a scrambling sequence generator, such as a scrambling sequence generator defined in 3GPP Technical Specification 36.211, Section 7.2, Release 18. An initialization sequence for the scrambling sequence generator may use any parameter or value described herein and/or j.

In some aspects, a number of TBs (denoted M TBs) may be interleaved with a set of N redundancy versions (RVs) of the MTBs (with NRVs per TB). The interleaving may be performed in time over a set of M×N MBSFN subframes. The subframes over which the N RVs of each of these M TBs are denoted herein as s₁, s₂, . . . , SN. A TB may be segmented into C CBs (which may be distinct from C that defines the number of columns above), and a coded bit sequence (post-scrambling) of the C CBs is denoted herein as

$$b = [ {b}_{1}^{T} , {b}_{2}^{T} , … , {b}_{C}^{T} ] .$$

For example,

$${b}_{1}^{T}$$

may represent a un sequence from a first CB, of the C CBs derived from a single TB. According to some aspects herein, the coded bit sequence b may be cyclically shifted according to CB indexes, such as based on a number of RVs in the set of N RVs, a number (C) of CBs in the TB, and an OFDM numerology. Thus, the cyclic shift can be generally applied for any number of CBs relative to other cyclic shift approaches where a circular offset is equal to a subframe number irrespective of the CBs transmitted, and may provide a gain of approximately 2.8 decibels (dB) for any number of CBs. For example, for the i^{th} RV of the TB mapped to subframe sᵢ, i=0, . . . , N−1, prior to bit-to-symbol mapping and resource element mapping, the coded bit sequence may be cyclically shifted with CB indexes π(i,j) such that the output coded bit sequence reads as

$$b = [ {b}_{π ( i , 1 )}^{T} , {b}_{π ( i , 2 )}^{T} , … , {b}_{π ( i , C )}^{T} ] ,$$

where the cyclic shift function π(i,j) may depend on the number of RVs, number of CBs in the TB, and the OFDM numerology. For example, the bit sequence [\tilde{b}(0), \tilde{b}(1), . . . \tilde{b}(M_{bit}−1)](where M_{bit} represents a total number of bits of the bit sequence) for the i^{th} subframe of the time-interleaved TB may be cyclically shifted by

$$( i \times ⌊ \frac{\# CBs}{N} ⌋ \times ⌊ \frac{{M}_{bit}}{\# CBs} ⌋ )$$

bits, where i∈{0,1, . . . , N−1}, N denotes the number of subframes to which the time-interleaved TB is mapped, and #CBs denotes the number of CBs in the time-interleaved (scaled) TB.

In some aspects, the cyclic shift is consecutive across RVs of the NRVs. For example, the cyclic shift function may be defined as π(i,j)=(mod(j+i·f(C,N),C)), such that a function of C and N scales the value of i, which denotes a current subframe. Thus, regardless of how RV indexes are configured, the cyclic shift across RVs is consistent, which reduces implementation complexity. In some other aspects, the cyclic shift is dependent on an RV index across RVs, which provides improved interleaving performance relative to an approach that is agnostic to RV index. In these examples, the cyclic shift function may be defined as π(i,j)=(mod(j+rvᵢ·f(C,N),C), where rv, denotes the RV index transmitted in the corresponding subframe (such that the RV index is used to determine the cyclic shift). In these expressions, as some examples, f(C,N) may be defined as

$$f ( C , N ) = ⌊ \frac{C}{N} ⌋$$

(e.g., the floor of C/N, splitting the frequency domain resources into C/N parts),

$$f ( C , N ) = round ( \frac{C}{N} )$$

(e.g., a rounded value of C/N), or

$$f ( C , N ) = ⌈ \frac{C}{N} ⌉$$

(e.g., the ceiling of C/N).

Certain aspects provide a method for wireless communications by a user equipment (UE). The method includes receiving, in a set of time intervals, a broadcast or multicast transmission of a transport block, the transport block comprising a plurality of code blocks (CBs), wherein portions of the plurality of CBs are interleaved in the set of time intervals according to an interleaving configuration that is associated with at least one of: a number of CBs in the plurality of CBs, a numerology of the broadcast or multicast transmission, a transport block size of the transport block, a symbol index associated with the set of time intervals, or a modulation and coding scheme of the broadcast or multicast transmission; performing deinterleaving of the portions of the plurality of CBs to obtain the plurality of CBs; and decoding the plurality of CBs.

Certain aspects provide a method for wireless communications by a UE. The method includes receiving, in a set of time intervals, a broadcast or multicast transmission of a transport block, the transport block comprising a plurality of CBs, wherein portions of the plurality of CBs are interleaved in the set of time intervals according to an interleaving matrix that is subject to an element rearrangement of a row or column of the interleaving matrix, wherein the element rearrangement is associated with at least one of: a number of CBs in the plurality of CBs, a numerology of the broadcast or multicast transmission, a number of columns in the interleaving matrix, a symbol index associated with the set of time intervals, a multicast radio network temporary identifier of the broadcast or multicast transmission, a multicast/broadcast single frequency network area identity associated with the UE, or a slot number of the set of time intervals; performing deinterleaving of the portions of the plurality of CBs to obtain the plurality of CBs; and decoding the plurality of CBs.

Certain aspects provide a method for wireless communications by a network entity. The method includes generating a transport block comprising a plurality of CBs; and transmitting, in a set of time intervals, a broadcast or multicast transmission of the transport block, the transport block comprising a plurality of CBs, wherein portions of the plurality of CBs are interleaved in the set of time intervals according to an interleaving configuration that is associated with at least one of: a number of CBs in the plurality of CBs, a numerology of the broadcast or multicast transmission, a transport block size of the transport block, a symbol index associated with the set of time intervals, or a modulation and coding scheme of the broadcast or multicast transmission.

Certain aspects provide a method for wireless communications by a network entity. The method includes generating a transport block comprising a plurality of CBs; and transmitting, in a set of time intervals, a broadcast or multicast transmission of the transport block, the transport block comprising a plurality of CBs, wherein portions of the plurality of CBs are interleaved in the set of time intervals according to an interleaving matrix that is subject to an element rearrangement of a row or column of the interleaving matrix, wherein the element rearrangement is associated with at least one of: a number of CBs in the plurality of CBs, a numerology of the broadcast or multicast transmission, a number of columns in the interleaving matrix, a symbol index associated with the set of time intervals, a multicast radio network temporary identifier of the broadcast or multicast transmission, a multicast/broadcast single frequency network area identity, or a slot number of the set of time intervals.

Certain aspects provide a method for wireless communications by a UE. The method includes receiving, in a set of time intervals, a broadcast or multicast transmission of plurality of RVs of a transport block, the transport block comprising a plurality of CBS, wherein a bit sequence of an RV of the plurality of RVs, in a time interval of the set of time intervals, is associated with a cyclic shift that is based on a number of the plurality of RVs; and decoding the plurality of CBs.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts a method for wireless communications.

FIG. 6 depicts another method for wireless communications.

FIG. 7 depicts another method for wireless communications.

FIG. 8 depicts another method for wireless communications.

FIG. 9 depicts aspects of an example communications device.

FIG. 10 depicts aspects of an example communications device.

FIG. 11 depicts aspects of an example communications device.

FIG. 12 depicts aspects of an example communications device.

FIG. 13 depicts another method for wireless communications.

FIG. 14 depicts aspects of an example communications device.

### DETAILED DESCRIPTION

Aspects of the present disclosure provide apparatuses, methods, processing systems, and computer-readable mediums for interleaving in broadcast or multicast transmissions.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

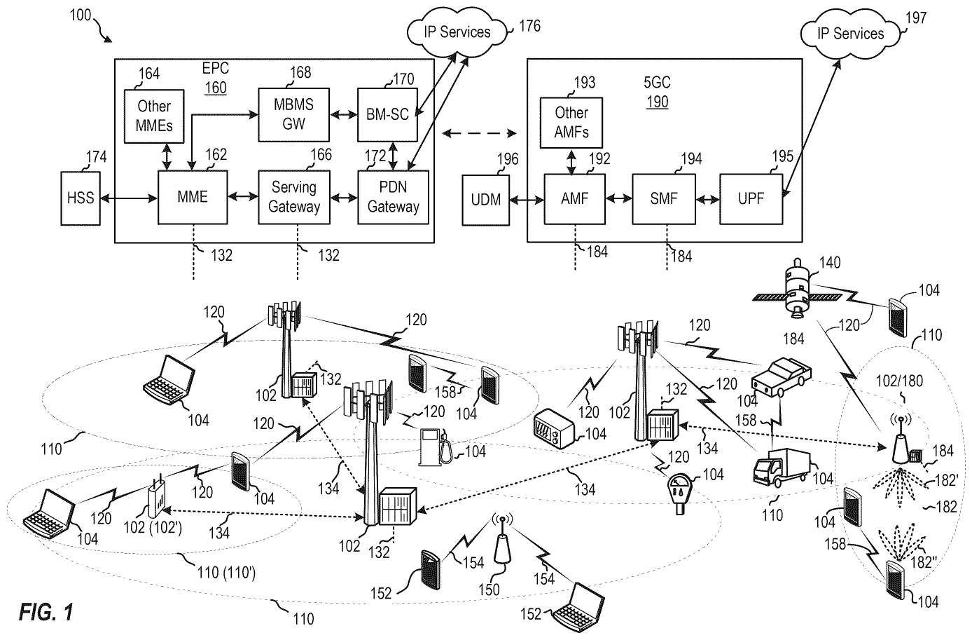

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IOT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

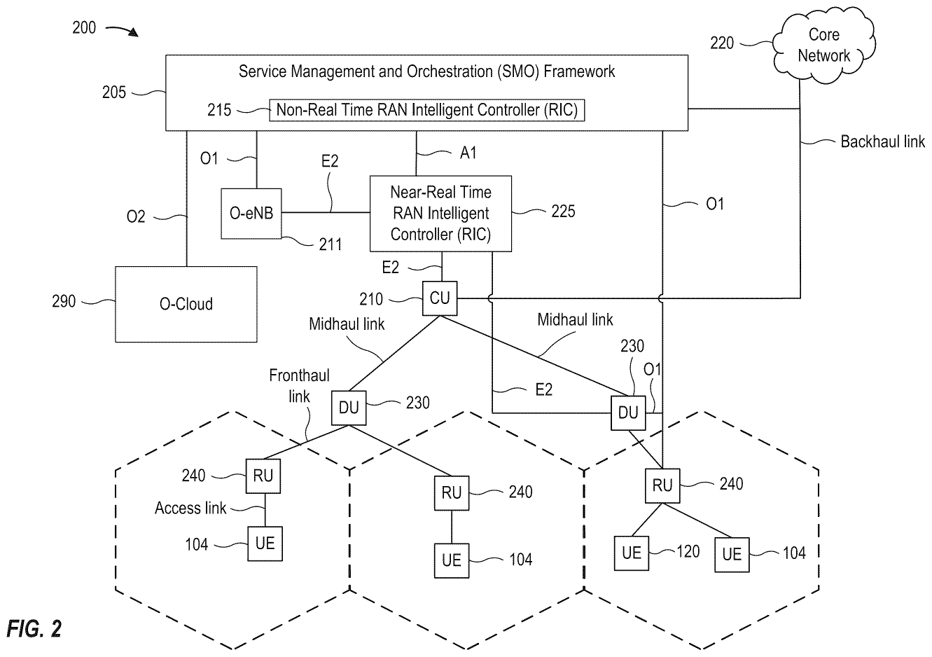

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an s₁ interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mm Wave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an 02 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

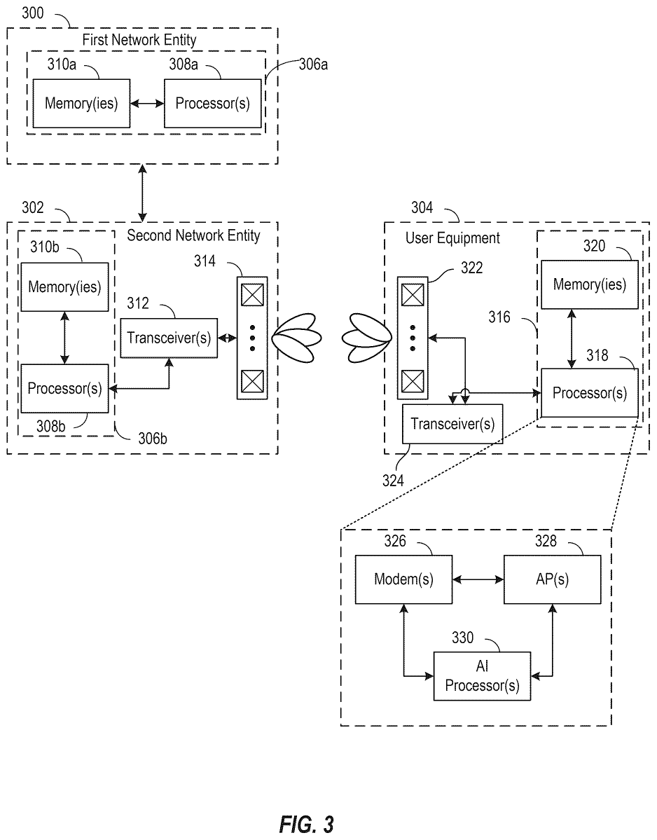

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof(all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

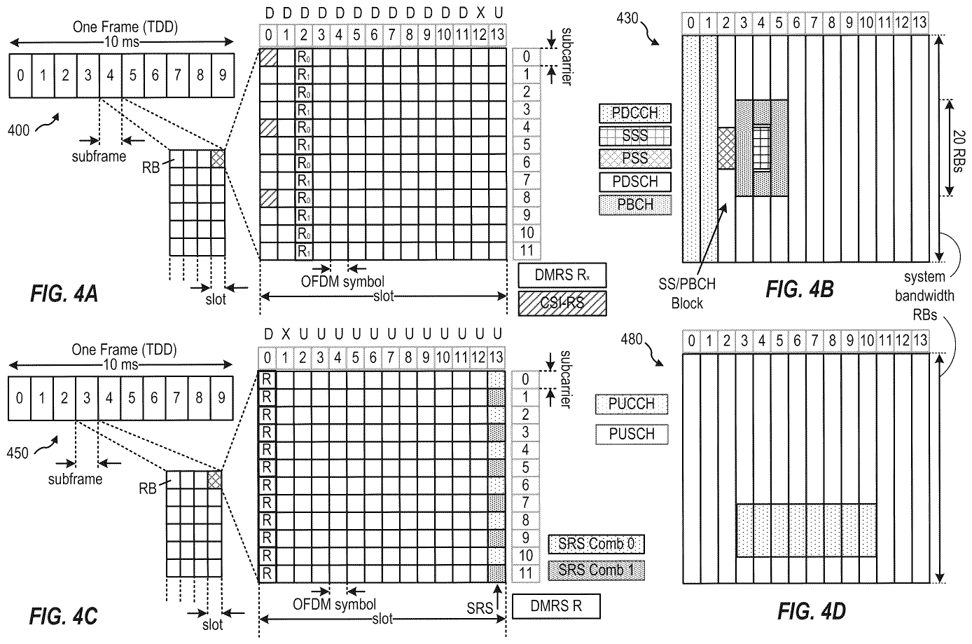

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology u, there are 24 slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 24×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Operations of a User Equipment

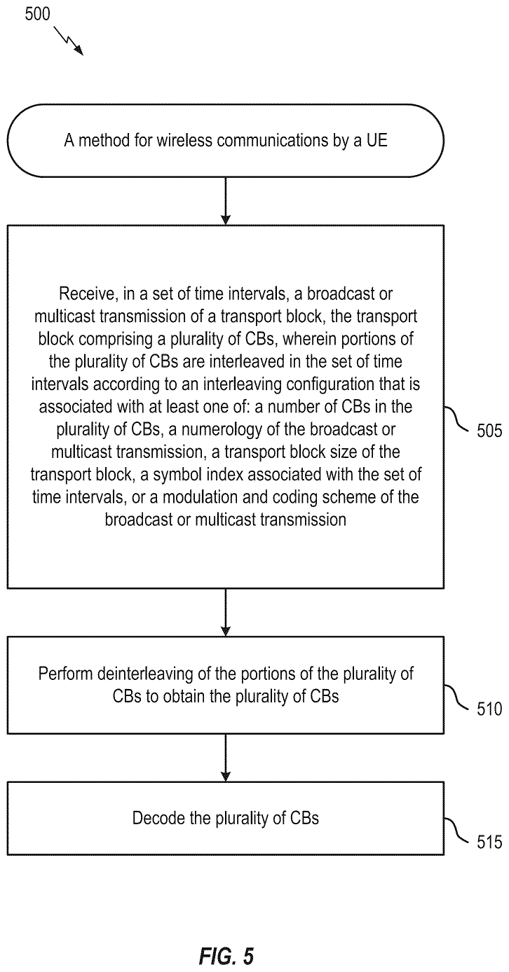

FIG. 5 shows a method 500 for wireless communications by a UE, such as UE 104 of FIG. 1 or UE 304 of FIG. 3.

Method 500 begins at block 505 with receiving, in a set of time intervals, a broadcast or multicast transmission of a transport block, the transport block comprising a plurality of CBs, wherein portions of the plurality of CBs are interleaved in the set of time intervals according to an interleaving configuration that is associated with at least one of: a number of CBs in the plurality of CBs, a numerology of the broadcast or multicast transmission, a transport block size of the transport block, a symbol index associated with the set of time intervals, or a modulation and coding scheme of the broadcast or multicast transmission.

Method 500 then proceeds to block 510 with performing deinterleaving of the portions of the plurality of CBs to obtain the plurality of CBs.

Method 500 then proceeds to block 515 with decoding the plurality of CBs.

In some aspects, the interleaving configuration comprises an interleaving matrix with a first number of rows and a second number of columns, wherein the portions of the plurality of CBs are interleaved according to the interleaving matrix.

In some aspects, tones of the plurality of CBs are input to the interleaving matrix in a column-wise fashion, and tones of the plurality of CBs are output from the interleaving matrix in a row-wise fashion to obtain the portions of the plurality of CBs.

In some aspects, the interleaving matrix is configured such that each column, of the second number of columns, contains (modulo spillover) tones of a single CB of the plurality of CBs.

In some aspects, the second number of columns is based on the number of CBs.

In some aspects, the second number of columns is based on the numerology.

In some aspects, the second number of columns is based on the transport block size.

In some aspects, the second number of columns is based on the symbol index.

In some aspects, the second number of columns is based on the modulation and coding scheme.

In some aspects, the second number of columns is based on a greatest common divisor of a quantity of CBs of the plurality of CBs and a quantity of time intervals in the set of time intervals.

In some aspects, method 500 further includes receiving signaling that indicates the interleaving configuration.

In some aspects, method 500 further includes determining the interleaving configuration.

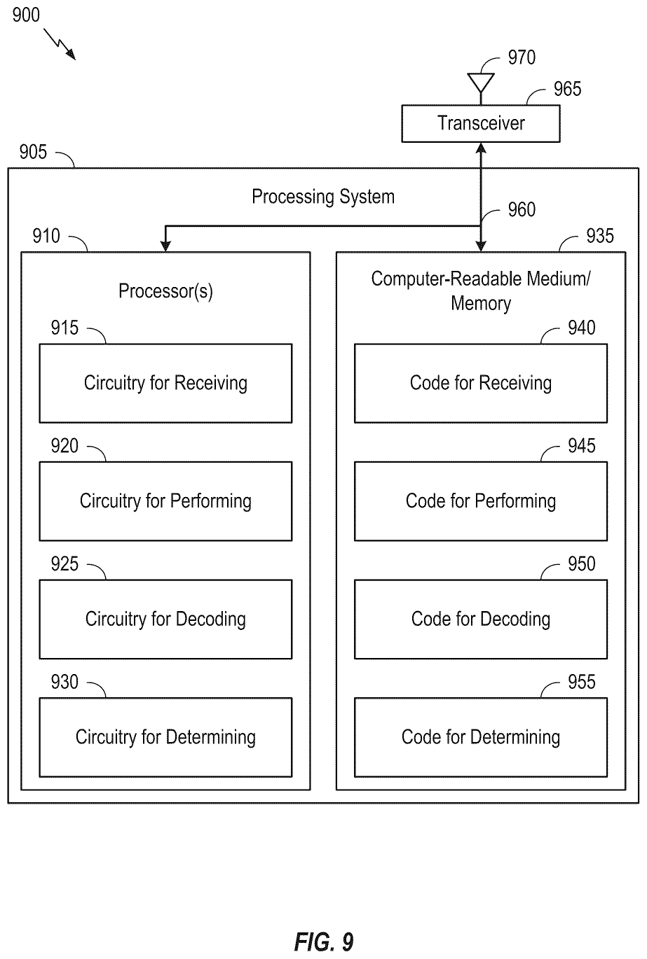

In some aspects, method 500, or any aspect related to it, may be performed by an apparatus, such as communications device 900 of FIG. 9, which includes various components operable, configured, or adapted to perform the method 500.

Communications device 900 is described below in further detail.

Note that FIG. 5 is just one example of a method, and other methods including fewer, additional, or alternative operations are possible consistent with this disclosure.

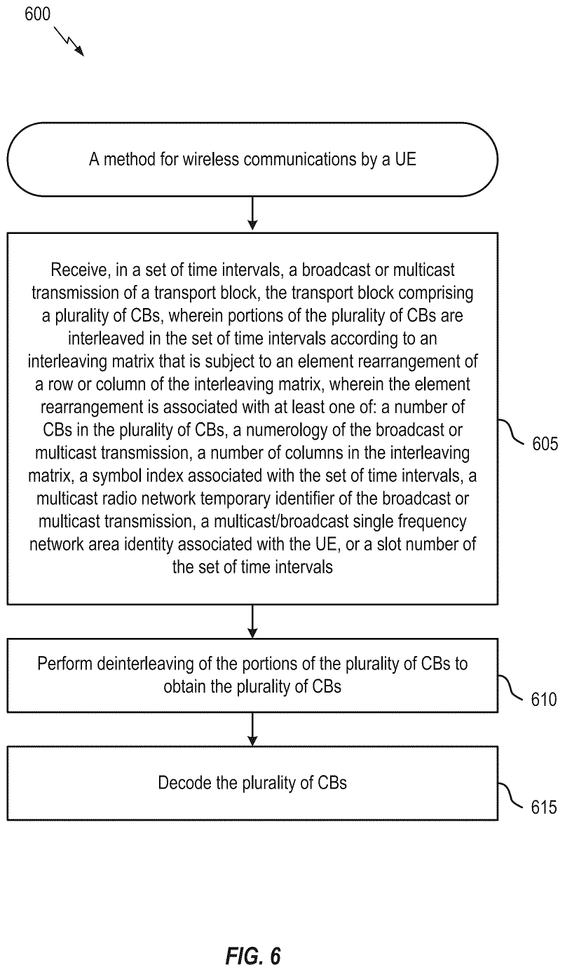

FIG. 6 shows a method 600 for wireless communications by a UE, such as UE 104 of FIG. 1 or UE 304 of FIG. 3. In some aspects, operations of method 600 may be combined with operations of method 500. For example, method 500 may include any one or more operations, steps, or aspects of method 600, and/or method 600 may include any one or more operations, steps, or aspects of method 500.

Method 600 begins at block 605 with receiving, in a set of time intervals, a broadcast or multicast transmission of a transport block, the transport block comprising a plurality of CBs, wherein portions of the plurality of CBs are interleaved in the set of time intervals according to an interleaving matrix that is subject to an element rearrangement of a row or column of the interleaving matrix, wherein the element rearrangement is associated with at least one of: a number of CBs in the plurality of CBs, a numerology of the broadcast or multicast transmission, a number of columns in the interleaving matrix, a symbol index associated with the set of time intervals, a multicast radio network temporary identifier of the broadcast or multicast transmission, a multicast/broadcast single frequency network area identity associated with the UE, or a slot number of the set of time intervals.

Method 600 then proceeds to block 610 with performing deinterleaving of the portions of the plurality of CBs to obtain the plurality of CBs.

Method 600 then proceeds to block 615 with decoding the plurality of CBs.

In some aspects, the element rearrangement comprises a cyclic shift.

In some aspects, the element rearrangement comprises a row or column permutation.

In some aspects, the element rearrangement is specific to the row or column.

In some aspects, method 600 further includes receiving an indication of the element rearrangement.

In some aspects, method 600 further includes determining the element rearrangement.

In some aspects, the element rearrangement is one of a plurality of element rearrangements that include a first element rearrangement comprising a first permutation of first elements in a column, where the first permutation for any particular first element in the column is the same across each column of the columns, thereby resulting in a common row permutation for each column, in the interleaving matrix, that conforms to a first target permutation, a second element rearrangement comprising a second permutation of second elements in a row, where the second permutation of any particular second element in the row is the same across each row of the rows, thereby resulting in a common column permutation for each row, in the interleaving matrix, that conforms to a second target permutation, and a third element rearrangement comprising a row-specific cyclic shift

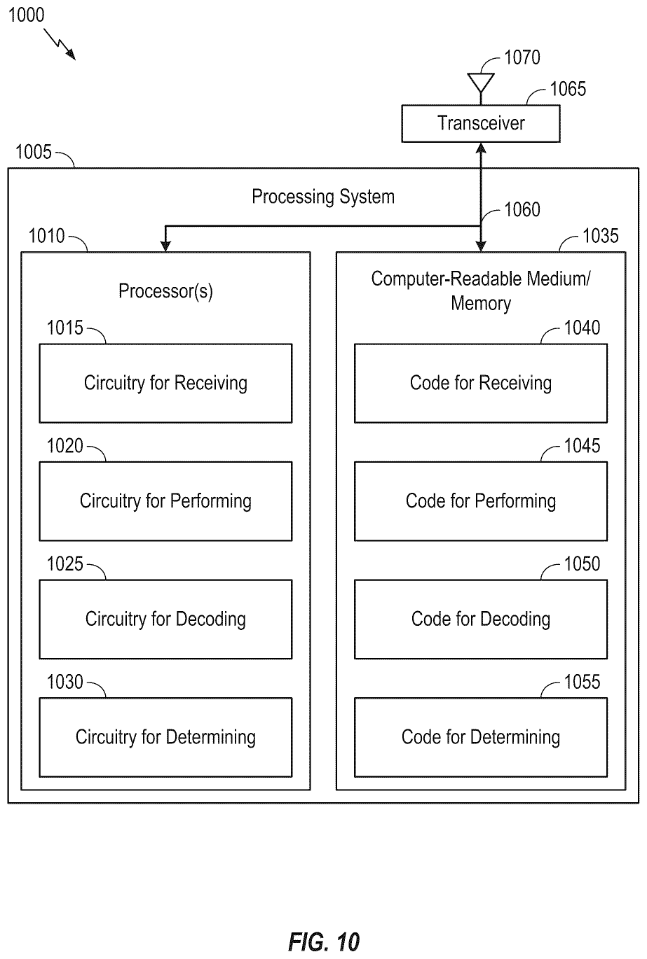

In some aspects, method 600, or any aspect related to it, may be performed by an apparatus, such as communications device 1000 of FIG. 10, which includes various components operable, configured, or adapted to perform the method 600. Communications device 1000 is described below in further detail.

Note that FIG. 6 is just one example of a method, and other methods including fewer, additional, or alternative operations are possible consistent with this disclosure.

### Example Operations of a Network Entity

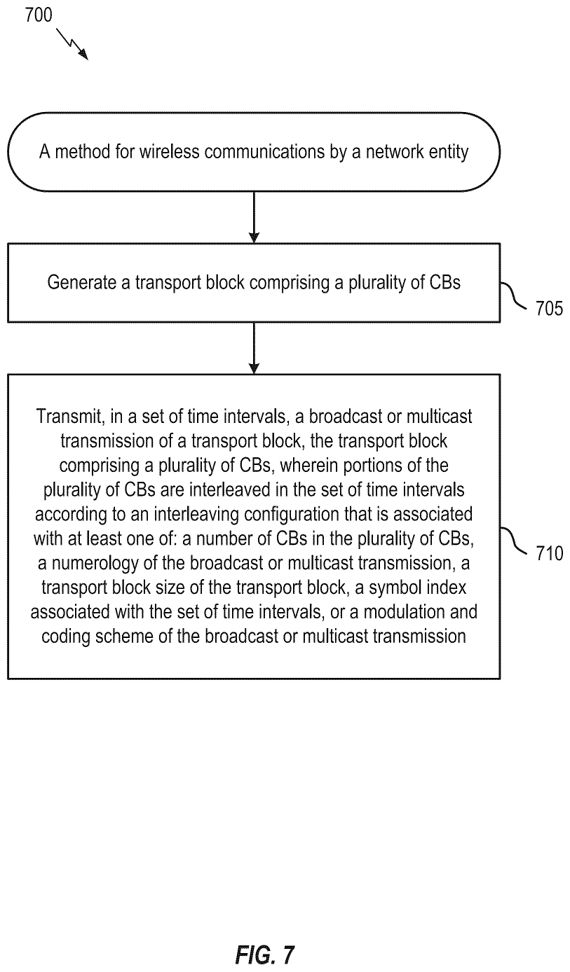

FIG. 7 shows a method 700 for wireless communications by a network entity, such as BS 102 of FIG. 1, a first network entity 300 or second network entity 302 of FIG. 3, or a disaggregated base station as discussed with respect to FIG. 2.

Method 700 begins at block 705 with generating a transport block comprising a plurality of CBs.

Method 700 then proceeds to block 710 with transmitting, in a set of time intervals, a broadcast or multicast transmission of a transport block, the transport block comprising a plurality of CBs, wherein portions of the plurality of CBs are interleaved in the set of time intervals according to an interleaving configuration that is associated with at least one of: a number of CBs in the plurality of CBs, a numerology of the broadcast or multicast transmission, a transport block size of the transport block, a symbol index associated with the set of time intervals, or a modulation and coding scheme of the broadcast or multicast transmission.

In some aspects, the interleaving configuration comprises an interleaving matrix with a first number of rows and a second number of columns, wherein the portions of the plurality of CBs are interleaved according to the interleaving matrix.

In some aspects, tones of the plurality of CBs are input to the interleaving matrix in a column-wise fashion, and tones of the plurality of CBs are output from the interleaving matrix in a row-wise fashion to obtain the portions of the plurality of CBs.

In some aspects, the interleaving matrix is configured such that each column, of the second number of columns, contains (modulo spillover) tones of a single CB of the plurality of CBs.

In some aspects, the second number of columns is based on the number of CBs.

In some aspects, the second number of columns is based on the numerology.

In some aspects, the second number of columns is based on the transport block size.

In some aspects, the second number of columns is based on the symbol index.

In some aspects, the second number of columns is based on the modulation and coding scheme.

In some aspects, the second number of columns is based on a greatest common divisor of a quantity of CBs of the plurality of CBs and a quantity of time intervals in the set of time intervals.

In certain aspects, method 700 further includes transmitting signaling that indicates the interleaving configuration.

In certain aspects, method 700 further includes determining the interleaving configuration.

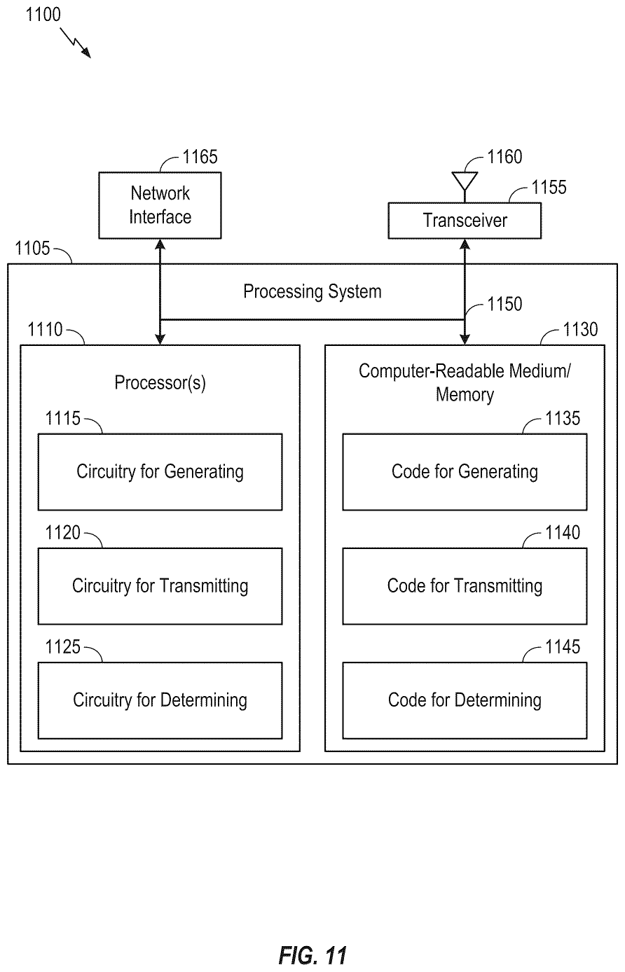

In some aspects, method 700, or any aspect related to it, may be performed by an apparatus, such as communications device 1100 of FIG. 11, which includes various components operable, configured, or adapted to perform the method 700. Communications device 1100 is described below in further detail.

Note that FIG. 7 is just one example of a method, and other methods including fewer, additional, or alternative operations are possible consistent with this disclosure.

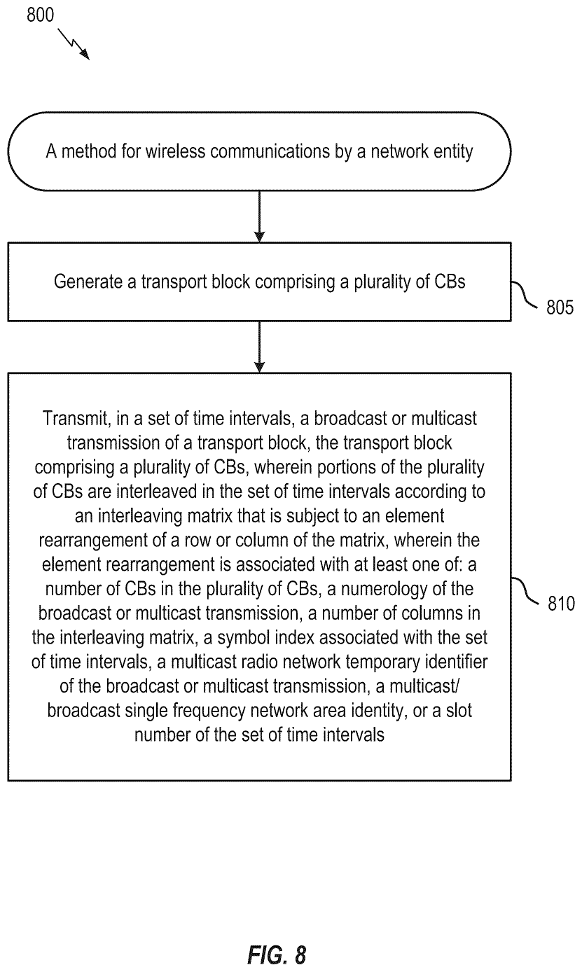

FIG. 8 shows a method 800 for wireless communications by a network entity, such as BS 102 of FIG. 1, a first network entity 300 or second network entity 302 of FIG. 3, or a disaggregated base station as discussed with respect to FIG. 2. In some aspects, operations of method 800 may be combined with operations of method 600. For example, method 700 may include any one or more operations, steps, or aspects of method 800, and/or method 800 may include any one or more operations, steps, or aspects of method 600.

Method 800 begins at block 805 with generating a transport block comprising a plurality of CBs.

Method 800 then proceeds to block 810 with transmitting, in a set of time intervals, a broadcast or multicast transmission of a transport block, the transport block comprising a plurality of CBs, wherein portions of the plurality of CBs are interleaved in the set of time intervals according to an interleaving matrix that is subject to an element rearrangement of a row or column of the interleaving matrix, wherein the element rearrangement is associated with at least one of: a number of CBs in the plurality of CBs, a numerology of the broadcast or multicast transmission, a number of columns in the interleaving matrix, a symbol index associated with the set of time intervals, a multicast radio network temporary identifier of the broadcast or multicast transmission, a multicast/broadcast single frequency network area identity, or a slot number of the set of time intervals.

In some aspects, the element rearrangement comprises a cyclic shift.

In some aspects, the element rearrangement comprises a row or column permutation.

In some aspects, the element rearrangement is specific to the row or column.

In certain aspects, method 800 further includes transmitting an indication of the element rearrangement.

In certain aspects, method 800 further includes determining the element rearrangement.

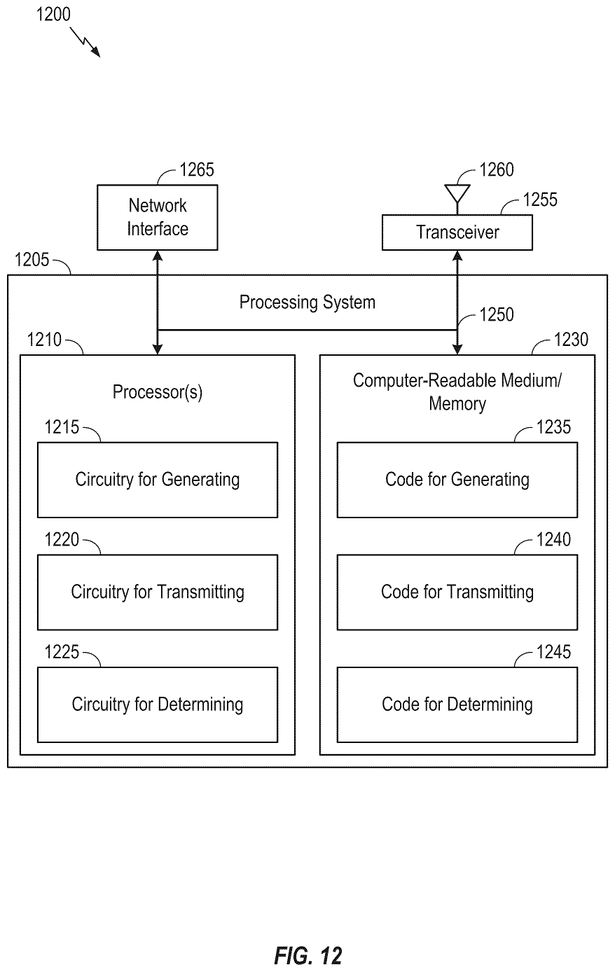

In some aspects, method 800, or any aspect related to it, may be performed by an apparatus, such as communications device 1200 of FIG. 12, which includes various components operable, configured, or adapted to perform the method 800. Communications device 1200 is described below in further detail.

Note that FIG. 8 is just one example of a method, and other methods including fewer, additional, or alternative operations are possible consistent with this disclosure.

### Example Communications Devices

FIG. 9 depicts aspects of an example communications device 900 configured for wireless communications. In some aspects, communications device 900 is a user equipment, such as UE 104 described above with respect to FIG. 1 or UE 304 described with respect to FIG. 3.

The communications device 900 includes a processing system 905 coupled to a transceiver 965 (e.g., a transmitter and/or a receiver). The transceiver 965 is configured to transmit and receive signals for the communications device 900 via an antenna 970, such as the various signals as described herein. The processing system 905 may be configured to perform processing functions for the communications device 900, including processing signals received and/or to be transmitted by the communications device 900.

The processing system 905 includes one or more processors 910 and a computer-readable medium/memory 935. In various aspects, the one or more processors 910 may be representative of the one or more processors 318 described with respect to FIG. 3. The one or more processors 910 are coupled to a computer-readable medium/memory 935 via a bus 960. In some aspects, the computer-readable medium/memory 935 may be representative of the one or more memories 320 described with respect to FIG. 3. The computer-readable medium/memory 935 is a non-transitory computer-readable medium/memory. In certain aspects, the computer-readable medium/memory 935 is configured to store instructions (e.g., computer-executable code), that when executed by the one or more processors 910, cause the one or more processors 910 to perform the method 500 described with respect to FIG. 5, or any aspect related to it, including any operations described in relation to FIG. 5. Note that reference to a processor performing a function of communications device 900 may include one or more processors performing that function of communications device 900, such as in a distributed fashion.

In the depicted example, computer-readable medium/memory 935 stores code (e.g., executable instructions), including code for receiving 940, code for performing 945, code for decoding 950, and code for determining 955. Processing of the code 940-955 may enable and cause the communications device 900 to perform the method 500 described with respect to FIG. 5, or any aspect related to it. For instance, in some aspects, code for receiving 940 includes code for receiving, in a set of time intervals, a broadcast or multicast transmission of a transport block, the transport block comprising a plurality of CBs, wherein portions of the plurality of CBs are interleaved in the set of time intervals according to an interleaving configuration that is associated with at least one of: a number of CBs in the plurality of CBs, a numerology of the broadcast or multicast transmission, a transport block size of the transport block, a symbol index associated with the set of time intervals, or a modulation and coding scheme of the broadcast or multicast transmission. In some aspects, code for performing 945 includes code for performing deinterleaving of the portions of the plurality of CBs to obtain the plurality of CBs. In some aspects, code for decoding 950 includes code for decoding the plurality of CBs.

The one or more processors 910 include circuitry configured to implement (e.g., execute) the code stored in the computer-readable medium/memory 935, including circuitry for receiving 915, circuitry for performing 920, circuitry for decoding 925, and circuitry for determining 930. Processing with circuitry 915-930 may enable and cause the communications device 900 to perform the method 500 described with respect to FIG. 5, or any aspect related to it. For instance, in some aspects, circuitry for receiving 915 includes circuitry for receiving, in a set of time intervals, a broadcast or multicast transmission of a transport block, the transport block comprising a plurality of CBs, wherein portions of the plurality of CBs are interleaved in the set of time intervals according to an interleaving configuration that is associated with at least one of: a number of CBs in the plurality of CBs, a numerology of the broadcast or multicast transmission, a transport block size of the transport block, a symbol index associated with the set of time intervals, or a modulation and coding scheme of the broadcast or multicast transmission. In some aspects, circuitry for performing 920 includes circuitry for performing deinterleaving of the portions of the plurality of CBs to obtain the plurality of CBs. In some aspects, circuitry for decoding 925 includes circuitry for decoding the plurality of CBs.

More generally, means for communicating, transmitting, sending or outputting for transmission may include the one or more transceivers 324, one or more antenna 322 and/or processing system 316 of the UE 304 illustrated in FIG. 3, transceiver 965 and/or antenna 970 of the communications device 900 in FIG. 9, and/or one or more processors 910 of the communications device 900 in FIG. 9. Means for communicating, receiving or obtaining may include the one or more transceivers 324, one or more antennas 322, and/or processing system 316 of the UE 304 illustrated in FIG. 3, transceiver 965 and/or antenna 970 of the communications device 900 in FIG. 9, and/or one or more processors 910 of the communications device 900 in FIG. 9.

FIG. 10 depicts aspects of an example communications device 1000 configured for wireless communications. In some aspects, communications device 1000 is a user equipment, such as UE 104 described above with respect to FIG. 1 or UE 304 described with respect to FIG. 3.

The communications device 1000 includes a processing system 1005 coupled to a transceiver 1065 (e.g., a transmitter and/or a receiver). The transceiver 1065 is configured to transmit and receive signals for the communications device 1000 via an antenna 1070, such as the various signals as described herein. The processing system 1005 may be configured to perform processing functions for the communications device 1000, including processing signals received and/or to be transmitted by the communications device 1000.

The processing system 1005 includes one or more processors 1010 and a computer-readable medium/memory 1035. In various aspects, the one or more processors 1010 may be representative of the one or more processors 318 described with respect to FIG. 3. The one or more processors 1010 are coupled to a computer-readable medium/memory 1035 via a bus 1060. In some aspects, the computer-readable medium/memory 1035 may be representative of the one or more memories 320 described with respect to FIG. 3. The computer-readable medium/memory 1035 is a non-transitory computer-readable medium/memory. In certain aspects, the computer-readable medium/memory 1035 is configured to store instructions (e.g., computer-executable code), that when executed by the one or more processors 1010, cause the one or more processors 1010 to perform the method 600 described with respect to FIG. 6, or any aspect related to it, including any operations described in relation to FIG. 6. Note that reference to a processor performing a function of communications device 1000 may include one or more processors performing that function of communications device 1000, such as in a distributed fashion.

In the depicted example, computer-readable medium/memory 1035 stores code (e.g., executable instructions), including code for receiving 1040, code for performing 1045, code for decoding 1050, and code for determining 1055. Processing of the code 1040-1055 may enable and cause the communications device 1000 to perform the method 600 described with respect to FIG. 6, or any aspect related to it. For instance, in some aspects, code for receiving 1040 includes code for receiving, in a set of time intervals, a broadcast or multicast transmission of a transport block, the transport block comprising a plurality of CBs, wherein portions of the plurality of CBs are interleaved in the set of time intervals according to an interleaving matrix that is subject to an element rearrangement of a row or column of the interleaving matrix, wherein the element rearrangement is associated with at least one of: a number of CBs in the plurality of CBs, a numerology of the broadcast or multicast transmission, a number of columns in the interleaving matrix, a symbol index associated with the set of time intervals, a multicast radio network temporary identifier of the broadcast or multicast transmission, a multicast/broadcast single frequency network area identity associated with the UE, or a slot number of the set of time intervals. In some aspects, code for performing 1045 includes code for performing deinterleaving of the portions of the plurality of CBs to obtain the plurality of CBs. In some aspects, code for decoding 1050 includes code for decoding the plurality of CBs.

The one or more processors 1010 include circuitry configured to implement (e.g., execute) the code stored in the computer-readable medium/memory 1035, including circuitry for receiving 1015, circuitry for performing 1020, circuitry for decoding 1025, and circuitry for determining 1030. Processing with circuitry 1015-1030 may enable and cause the communications device 1000 to perform the method 600 described with respect to FIG. 6, or any aspect related to it. For instance, in some aspects circuitry for receiving 1015 includes circuitry for receiving, in a set of time intervals, a broadcast or multicast transmission of a transport block, the transport block comprising a plurality of CBs, wherein portions of the plurality of CBs are interleaved in the set of time intervals according to an interleaving matrix that is subject to an element rearrangement of a row or column of the interleaving matrix, wherein the element rearrangement is associated with at least one of: a number of CBs in the plurality of CBs, a numerology of the broadcast or multicast transmission, a number of columns in the interleaving matrix, a symbol index associated with the set of time intervals, a multicast radio network temporary identifier of the broadcast or multicast transmission, a multicast/broadcast single frequency network area identity associated with the UE, or a slot number of the set of time intervals. In some aspects, circuitry for performing 1020 includes circuitry for performing deinterleaving of the portions of the plurality of CBs to obtain the plurality of CBs. In some aspects, circuitry for decoding 1025 includes circuitry for decoding the plurality of CBs.

More generally, means for communicating, transmitting, sending or outputting for transmission may include the one or more transceivers 324, one or more antenna 322 and/or processing system 316 of the UE 304 illustrated in FIG. 3, transceiver 1065 and/or antenna 1070 of the communications device 1000 in FIG. 10, and/or one or more processors 1010 of the communications device 1000 in FIG. 10. Means for communicating, receiving or obtaining may include the one or more transceivers 324, one or more antennas 322, and/or processing system 316 of the UE 304 illustrated in FIG. 3, transceiver 1065 and/or antenna 1070 of the communications device 1000 in FIG. 10, and/or one or more processors 1010 of the communications device 1000 in FIG. 10.

FIG. 11 depicts aspects of an example communications device configured for wireless communications. In some aspects, communications device 1100 is a network entity, such as BS 102 of FIG. 1, first network entity 300 or second network entity 302 of FIG. 3, or a disaggregated base station as discussed with respect to FIG. 2.

The communications device 1100 includes a processing system 1105 coupled to a transceiver 1155 (e.g., a transmitter and/or a receiver) and/or a network interface 1165. The transceiver 1155 is configured to transmit and receive signals for the communications device 1100 via an antenna 1160, such as the various signals as described herein. The network interface 1165 is configured to obtain and send signals for the communications device 1100 via communications link(s), such as a backhaul link, midhaul link, and/or fronthaul link as described herein, such as with respect to FIG. 2. The processing system 1105 may be configured to perform processing functions for the communications device 1100, including processing signals received and/or to be transmitted by the communications device 1100.

The processing system 1105 includes one or more processors 1110 and a computer-readable medium/memory 1130. In various aspects, one or more processors 1110 may be representative of the one or more processors 308, as described with respect to FIG. 3. The one or more processors 1110 are coupled to the computer-readable medium/memory 1130 via a bus 1150. In certain aspects, the computer-readable medium/memory 1130 is configured to store instructions (e.g., computer-executable code), including code 1135-1145, that when executed by the one or more processors 1110, cause the one or more processors 1110 to perform the method 700 described with respect to FIG. 7, or any aspect related to it, including any operations described in relation to FIG. 7. The computer-readable medium/memory 1130 is a non-transitory computer-readable medium/memory. Note that reference to a processor of communications device 1100 performing a function may include one or more processors of communications device 1100 performing that function, such as in a distributed fashion.

In the depicted example, the computer-readable medium/memory 1130 stores code (e.g., executable instructions), including code for generating 1135, code for transmitting 1140, and code for determining 1145. Processing of the code 1135-1145 may enable and cause the communications device 1100 to perform the method 700 described with respect to FIG. 7, or any aspect related to it. For instance, in some aspects, code for generating 1135 includes code for generating a transport block comprising a plurality of CBs. In some aspects, code for transmitting 1140 includes code for transmitting, in a set of time intervals, a broadcast or multicast transmission of a transport block, the transport block comprising a plurality of CBs, wherein portions of the plurality of CBs are interleaved in the set of time intervals according to an interleaving configuration that is associated with at least one of: a number of CBs in the plurality of CBs, a numerology of the broadcast or multicast transmission, a transport block size of the transport block, a symbol index associated with the set of time intervals, or a modulation and coding scheme of the broadcast or multicast transmission.

The one or more processors 1110 include circuitry configured to implement (e.g., execute) the code stored in the computer-readable medium/memory 1130, including circuitry for generating 1115, circuitry for transmitting 1120, and circuitry for determining 1125. Processing with circuitry 1115-1125 may enable and cause the communications device 1100 to perform the method 700 described with respect to FIG. 7, or any aspect related to it. For instance, in some aspects, circuitry for generating 1115 includes circuitry for generating a transport block comprising a plurality of CBs. In some aspects, circuitry for transmitting 1120 includes circuitry for transmitting, in a set of time intervals, a broadcast or multicast transmission of a transport block, the transport block comprising a plurality of CBs, wherein portions of the plurality of CBs are interleaved in the set of time intervals according to an interleaving configuration that is associated with at least one of: a number of CBs in the plurality of CBs, a numerology of the broadcast or multicast transmission, a transport block size of the transport block, a symbol index associated with the set of time intervals, or a modulation and coding scheme of the broadcast or multicast transmission.

Various components of the communications device 1100 may provide means for performing the method 700 described with respect to FIG. 7, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1155, antenna 1160, and/or network interface 1165 of the communications device 1100 in FIG. 11, and/or one or more processors 1110 of the communications device 1100 in FIG. 11. Means for communicating, receiving or obtaining may include the one or more transceivers 312, one or more antennas 314, and/or processing system 306 of the first network entity 300 or the second network entity 302 illustrated in FIG. 3, transceiver 1155, antenna 1160, and/or network interface 1165 of the communications device 1100 in FIG. 11, and/or one or more processors 1110 of the communications device 1100 in FIG. 11.

FIG. 12 depicts aspects of an example communications device configured for wireless communications. In some aspects, communications device 1200 is a network entity, such as BS 102 of FIG. 1, first network entity 300 or second network entity 302 of FIG. 3, or a disaggregated base station as discussed with respect to FIG. 2.

The communications device 1200 includes a processing system 1205 coupled to a transceiver 1255 (e.g., a transmitter and/or a receiver) and/or a network interface 1265. The transceiver 1255 is configured to transmit and receive signals for the communications device 1200 via an antenna 1260, such as the various signals as described herein. The network interface 1265 is configured to obtain and send signals for the communications device 1200 via communications link(s), such as a backhaul link, midhaul link, and/or fronthaul link as described herein, such as with respect to FIG. 2. The processing system 1205 may be configured to perform processing functions for the communications device 1200, including processing signals received and/or to be transmitted by the communications device 1200.

The processing system 1205 includes one or more processors 1210 and a computer-readable medium/memory 1230. In various aspects, one or more processors 1210 may be representative of the one or more processors 308, as described with respect to FIG. 3. The one or more processors 1210 are coupled to the computer-readable medium/memory 1230 via a bus 1250. In certain aspects, the computer-readable medium/memory 1230 is configured to store instructions (e.g., computer-executable code), including code 1235-1245, that when executed by the one or more processors 1210, cause the one or more processors 1210 to perform the method 800 described with respect to FIG. 8, or any aspect related to it, including any operations described in relation to FIG. 8. The computer-readable medium/memory 1230 is a non-transitory computer-readable medium/memory. Note that reference to a processor of communications device 1200 performing a function may include one or more processors of communications device 1200 performing that function, such as in a distributed fashion.

In the depicted example, the computer-readable medium/memory 1230 stores code (e.g., executable instructions), including code for generating 1235, code for transmitting 1240, and code for determining 1245. Processing of the code 1235-1245 may enable and cause the communications device 1200 to perform the method 800 described with respect to FIG. 8, or any aspect related to it. For instance, in some aspects, code for generating 1235 includes code for generating a transport block comprising a plurality of CBs. In some aspects, code for transmitting 1240 includes code for transmitting, in a set of time intervals, a broadcast or multicast transmission of a transport block, the transport block comprising a plurality of CBs, wherein portions of the plurality of CBs are interleaved in the set of time intervals according to an interleaving matrix that is subject to an element rearrangement of a row or column of the interleaving matrix, wherein the element rearrangement is associated with at least one of: a number of CBs in the plurality of CBs, a numerology of the broadcast or multicast transmission, a number of columns in the interleaving matrix, a symbol index associated with the set of time intervals, a multicast radio network temporary identifier of the broadcast or multicast transmission, a multicast/broadcast single frequency network area identity, or a slot number of the set of time intervals.

The one or more processors 1210 include circuitry configured to implement (e.g., execute) the code stored in the computer-readable medium/memory 1230, including circuitry for generating 1215, circuitry for transmitting 1220, and circuitry for determining 1225. Processing with circuitry 1215-1225 may enable and cause the communications device 1200 to perform the method 800 described with respect to FIG. 8, or any aspect related to it. For instance, in some aspects, circuitry for generating 1215 includes circuitry for generating a transport block comprising a plurality of CBs. In some aspects, circuitry for transmitting 1220 includes circuitry for transmitting, in a set of time intervals, a broadcast or multicast transmission of a transport block, the transport block comprising a plurality of CBs, wherein portions of the plurality of CBs are interleaved in the set of time intervals according to an interleaving matrix that is subject to an element rearrangement of a row or column of the interleaving matrix, wherein the element rearrangement is associated with at least one of: a number of CBs in the plurality of CBS, a numerology of the broadcast or multicast transmission, a number of columns in the interleaving matrix, a symbol index associated with the set of time intervals, a multicast radio network temporary identifier of the broadcast or multicast transmission, a multicast/broadcast single frequency network area identity, or a slot number of the set of time intervals.

Various components of the communications device 1200 may provide means for performing the method 800 described with respect to FIG. 8, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1255, antenna 1260, and/or network interface 1265 of the communications device 1200 in FIG. 12, and/or one or more processors 1210 of the communications device 1200 in FIG. 12. Means for communicating, receiving or obtaining may include the one or more transceivers 312, one or more antennas 314, and/or processing system 306 of the first network entity 300 or the second network entity 302 illustrated in FIG. 3, transceiver 1255, antenna 1260, and/or network interface 1265 of the communications device 1200 in FIG. 12, and/or one or more processors 1210 of the communications device 1200 in FIG. 12.

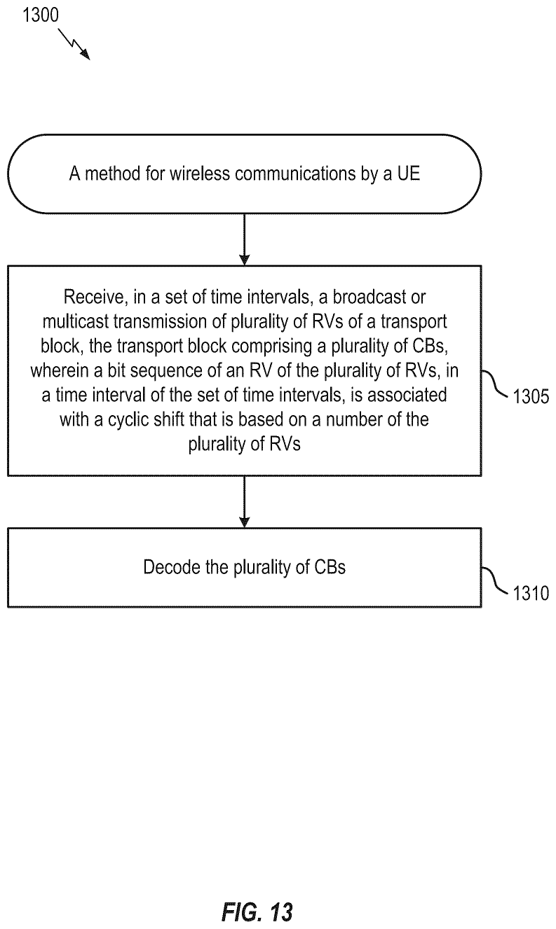

FIG. 13 shows a method 1300 for wireless communications by a UE, such as UE 104 of FIG. 1 or UE 304 of FIG. 3.

Method 1300 begins at block 1305 with receiving, in a set of time intervals, a broadcast or multicast transmission of plurality of RVs of a transport block, the transport block comprising a plurality of CBs, wherein a bit sequence of an RV of the plurality of RVs, in a time interval of the set of time intervals, is associated with a cyclic shift that is based on a number of the plurality of RVs.

Method 1300 then proceeds to block 1310 with decoding the plurality of CBs.

In some aspects, the cyclic shift is further based on at least one of a numerology of the broadcast or multicast transmission, or quantity of CBs of the plurality of CBs.

In some aspects, the cyclic shift is consecutive across RVs of the plurality of RVs.

In some aspects, the respective cyclic shift is based on an RV index of a CB associated with the RV.

In some aspects, the cyclic shift is a function of a number of time intervals of the set of time intervals and a number of CBs of the plurality of CBs.

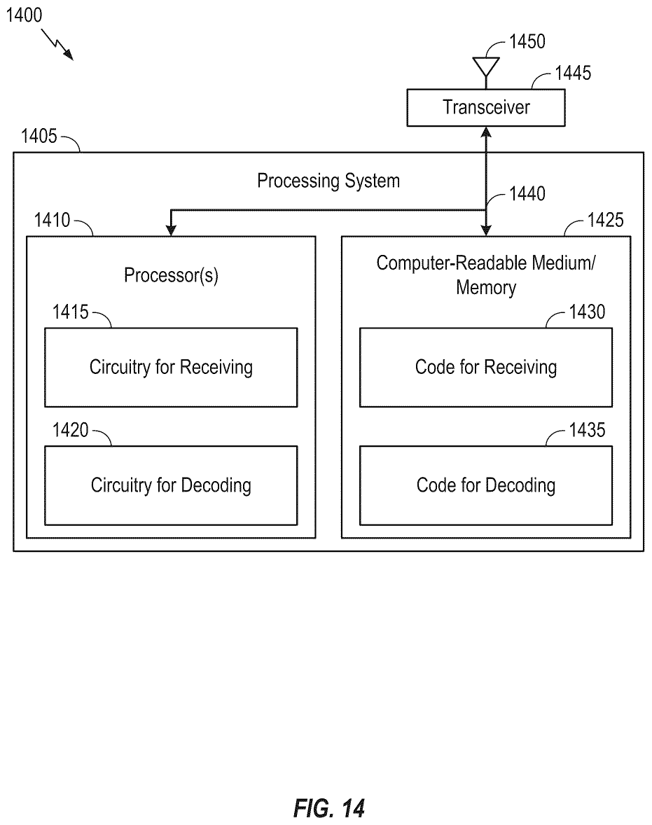

In some aspect, method 1300, or any aspect related to it, may be performed by an apparatus, such as communications device 1400 of FIG. 14, which includes various components operable, configured, or adapted to perform the method 1300. Communications device 1400 is described below in further detail.

Note that FIG. 13 is just one example of a method, and other methods including fewer, additional, or alternative operations are possible consistent with this disclosure.

FIG. 14 depicts aspects of an example communications device 1400 configured for wireless communications. In some aspects, communications device 1400 is a user equipment, such as UE 104 described above with respect to FIG. 1 or UE 304 described with respect to FIG. 3.

The communications device 1400 includes a processing system 1405 coupled to a transceiver 1445 (e.g., a transmitter and/or a receiver). The transceiver 1445 is configured to transmit and receive signals for the communications device 1400 via an antenna 1450, such as the various signals as described herein. The processing system 1405 may be configured to perform processing functions for the communications device 1400, including processing signals received and/or to be transmitted by the communications device 1400.

The processing system 1405 includes one or more processors 1410 and a computer-readable medium/memory 1425. In various aspects, the one or more processors 1410 may be representative of the one or more processors 318 described with respect to FIG. 3. The one or more processors 1410 are coupled to a computer-readable medium/memory 1425 via a bus 1440. In some aspects, the computer-readable medium/memory 1425 may be representative of the one or more memories 320 described with respect to FIG. 3. The computer-readable medium/memory 1425 is a non-transitory computer-readable medium/memory. In certain aspects, the computer-readable medium/memory 1425 is configured to store instructions (e.g., computer-executable code), that when executed by the one or more processors 1410, cause the one or more processors 1410 to perform the method 1300 described with respect to FIG. 13, or any aspect related to it, including any operations described in relation to FIG. 13. Note that reference to a processor performing a function of communications device 1400 may include one or more processors performing that function of communications device 1400, such as in a distributed fashion.

In the depicted example, computer-readable medium/memory 1425 stores code (e.g., executable instructions), including code for receiving 1430 and code for decoding 1435. Processing of the code 1430 and 1435 may enable and cause the communications device 1400 to perform the method 1300 described with respect to FIG. 13, or any aspect related to it.

The one or more processors 1410 include circuitry configured to implement (e.g., execute) the code stored in the computer-readable medium/memory 1425, including circuitry for receiving 1415 and circuitry for decoding 1420. Processing with circuitry 1415 and 1420 may enable and cause the communications device 1400 to perform the method 1300 described with respect to FIG. 13, or any aspect related to it.

More generally, means for communicating, transmitting, sending or outputting for transmission may include the one or more transceivers 324, one or more antenna 322 and/or processing system 316 of the UE 304 illustrated in FIG. 3, transceiver 1445 and/or antenna 1450 of the communications device 1400 in FIG. 14, and/or one or more processors 1410 of the communications device 1400 in FIG. 14. Means for communicating, receiving or obtaining may include the one or more transceivers 324, one or more antennas 322, and/or processing system 316 of the UE 304 illustrated in FIG. 3, transceiver 1445 and/or antenna 1450 of the communications device 1400 in FIG. 14, and/or one or more processors 1410 of the communications device 1400 in FIG. 14.

### Example Clauses

Implementation examples are described in the following numbered clauses:

Clause 1: A method for wireless communications by a UE comprising: receiving, in a set of time intervals, a broadcast or multicast transmission of a transport block, the transport block comprising a plurality of CBs, wherein portions of the plurality of CBs are interleaved in the set of time intervals according to an interleaving configuration that is associated with at least one of: a number of CBs in the plurality of CBs, a numerology of the broadcast or multicast transmission, a transport block size of the transport block, a symbol index associated with the set of time intervals, or a modulation and coding scheme of the broadcast or multicast transmission; performing deinterleaving of the portions of the plurality of CBs to obtain the plurality of CBs; and decoding the plurality of CBs.

Clause 2: The method of Clause 1, wherein the interleaving configuration comprises an interleaving matrix with a first number of rows and a second number of columns, wherein the portions of the plurality of CBs are interleaved according to the interleaving matrix.

Clause 3: The method of Clause 2, wherein tones of the plurality of CBs are input to the interleaving matrix in a column-wise fashion, and tones of the plurality of CBs are output from the interleaving matrix in a row-wise fashion to obtain the portions of the plurality of CBs.

Clause 4: The method of Clause 2, wherein the interleaving matrix is configured such that each column, of the second number of columns, contains (modulo spillover) tones of a single CB of the plurality of CBs.

Clause 5: The method of Clause 2, wherein the second number of columns is based on the number of CBs.

Clause 6: The method of Clause 2, wherein the second number of columns is based on the numerology.

Clause 7: The method of Clause 2, wherein the second number of columns is based on the transport block size.

Clause 8: The method of Clause 2, wherein the second number of columns is based on the symbol index.

Clause 9: The method of Clause 2, wherein the second number of columns is based on the modulation and coding scheme.

Clause 10: The method of Clause 2, wherein the second number of columns is based on a greatest common divisor of a quantity of CBs of the plurality of CBs and a quantity of time intervals in the set of time intervals.

Clause 11: The method of any one of Clauses 1-10, further comprising receiving signaling that indicates the interleaving configuration.

Clause 12: The method of any one of Clauses 1-11, further comprising determining the interleaving configuration.

Clause 13: A method for wireless communications by a UE comprising: receiving, in a set of time intervals, a broadcast or multicast transmission of a transport block, the transport block comprising a plurality of CBs, wherein portions of the plurality of CBs are interleaved in the set of time intervals according to an interleaving matrix that is subject to an element rearrangement of a row or column of the interleaving matrix, wherein the element rearrangement is associated with at least one of: a number of CBs in the plurality of CBs, a numerology of the broadcast or multicast transmission, a number of columns in the interleaving matrix, a symbol index associated with the set of time intervals, a multicast radio network temporary identifier of the broadcast or multicast transmission, a multicast/broadcast single frequency network area identity associated with the UE, or a slot number of the set of time intervals; performing deinterleaving of the portions of the plurality of CBs to obtain the plurality of CBs; and decoding the plurality of CBs.

Clause 14: The method of Clause 13, wherein the element rearrangement comprises a cyclic shift.

Clause 15: The method of any one of Clauses 13-14, wherein the element rearrangement comprises a row or column permutation.

Clause 16: The method of any one of Clauses 13-15, wherein the element rearrangement is specific to the row or column.

Clause 17: The method of any one of Clauses 13-16, further comprising receiving an indication of the element rearrangement.

Clause 18: The method of any one of Clauses 13-17, further comprising determining the element rearrangement.

Clause 19: A method for wireless communications by a network entity comprising: generating a transport block comprising a plurality of CBs; and transmitting, in a set of time intervals, a broadcast or multicast transmission of a transport block, the transport block comprising a plurality of CBs, wherein portions of the plurality of CBs are interleaved in the set of time intervals according to an interleaving configuration that is associated with at least one of: a number of CBs in the plurality of CBs, a numerology of the broadcast or multicast transmission, a transport block size of the transport block, a symbol index associated with the set of time intervals, or a modulation and coding scheme of the broadcast or multicast transmission.

Clause 20: The method of Clause 19, wherein the interleaving configuration comprises an interleaving matrix with a first number of rows and a second number of columns, wherein the portions of the plurality of CBs are interleaved according to the interleaving matrix.

Clause 21: The method of Clause 20, wherein tones of the plurality of CBs are input to the interleaving matrix in a column-wise fashion, and tones of the plurality of CBs are output from the interleaving matrix in a row-wise fashion to obtain the portions of the plurality of CBs.

Clause 22: The method of Clause 20, wherein the interleaving matrix is configured such that each CB, of the plurality of CBs, is confined to a respective single column of the second number of columns.

Clause 23: The method of Clause 20, wherein the second number of columns is based on the number of CBs.

Clause 24: The method of Clause 20, wherein the second number of columns is based on the numerology.

Clause 25: The method of Clause 20, wherein the second number of columns is based on the transport block size.

Clause 26: The method of Clause 20, wherein the second number of columns is based on the symbol index.

Clause 27: The method of Clause 20, wherein the second number of columns is based on the modulation and coding scheme.

Clause 28: The method of Clause 20, wherein the second number of columns is based on a greatest common divisor of a quantity of CBs of the plurality of CBs and a quantity of time intervals in the set of time intervals.

Clause 29: The method of any one of Clauses 19-28, further comprising transmitting signaling that indicates the interleaving configuration.

Clause 30: The method of any one of Clauses 19-29, further comprising determining the interleaving configuration.

Clause 31: A method for wireless communications by a network entity comprising: generating a transport block comprising a plurality of CBs; and transmitting, in a set of time intervals, a broadcast or multicast transmission of a transport block, the transport block comprising a plurality of CBs, wherein portions of the plurality of CBs are interleaved in the set of time intervals according to an interleaving matrix that is subject to an element rearrangement of a row or column of the interleaving matrix, wherein the element rearrangement is associated with at least one of: a number of CBs in the plurality of CBs, a numerology of the broadcast or multicast transmission, a number of columns in the interleaving matrix, a symbol index associated with the set of time intervals, a multicast radio network temporary identifier of the broadcast or multicast transmission, a multicast/broadcast single frequency network area identity, or a slot number of the set of time intervals.

Clause 32: The method of Clause 31, wherein the element rearrangement comprises a cyclic shift.

Clause 33: The method of any one of Clauses 31-32, wherein the element rearrangement comprises a row or column permutation.

Clause 34: The method of any one of Clauses 31-33, wherein the element rearrangement is specific to the row or column.

Clause 35: The method of any one of Clauses 31-34, further comprising transmitting an indication of the element rearrangement.

Clause 36: The method of any one of Clauses 31-35, further comprising determining the element rearrangement.

Clause 37: The method of any of Clauses 13-18, wherein the element rearrangement is one of a plurality of element rearrangements, wherein the plurality of element rearrangements include: a first element rearrangement comprising a first permutation of first elements in a column, where the first permutation for any particular first element in the column is the same across each column of the columns, thereby resulting in a common row permutation for each column, in the interleaving matrix, that conforms to a first target permutation, a second element rearrangement comprising a second permutation of second elements in a row, where the second permutation of any particular second element in the row is the same across each row of the rows, thereby resulting in a common column permutation for each row, in the interleaving matrix, that conforms to a second target permutation, and a third element rearrangement comprising a row-specific cyclic shift.

Clause 38: A method of wireless communication by a user equipment (UE), comprising: receiving, in a set of time intervals, a broadcast or multicast transmission of plurality of redundancy versions (RVs) of a transport block, the transport block comprising a plurality of code blocks (CBs), wherein each CB of the plurality of CBs is associated with a respective cyclic shift that is based on a number of the plurality of RVs; and decoding the plurality of CBs.

Clause 39: The method of Clause 38, wherein the cyclic shift is further based on at least one of a numerology of the broadcast or multicast transmission, or quantity of CBs of the plurality of CBs.

Clause 40: The method of any of Clauses 38-39, wherein the cyclic shift is consecutive across RVs of the plurality of RVs.

Clause 41: The method of any of Clauses 38-40, wherein the cyclic shift is based on an RV index of a CB associated with the RV.

Clause 42: The method of any of Clauses 38-41, wherein the cyclic shift is a function of a number of time intervals of the set of time intervals and a number of CBs of the plurality of CBs.

Clause 43: A method of wireless communication by a user equipment (UE), comprising: receiving, in a set of time intervals, a broadcast or multicast transmission of plurality of redundancy versions (RVs) of a transport block, the transport block comprising a plurality of code blocks (CBs), wherein a bit sequence of an RV of the plurality of RVs, in a time interval of the set of time intervals, is associated with a cyclic shift that is based on a number of the plurality of RVs.

Clause 44: The method of Clause 43, wherein the cyclic shift is further based on at least one of a numerology of the broadcast or multicast transmission, or quantity of CBs of the plurality of CBs.

Clause 45: The method of any of Clauses 43-44, wherein the cyclic shift is consecutive across RVs of the plurality of RVs.

Clause 46: The method of any of Clauses 43-45, wherein the cyclic shift is based on an RV index of a CB associated with the RV.

Clause 47: The method of any of Clauses 43-46, wherein the respective cyclic shift is a function of a number of time intervals of the set of time intervals and a number of CBs of the plurality of CBs.

Clause 48: One or more apparatuses, comprising: one or more memories comprising executable instructions; and one or more processors configured to execute the executable instructions and cause the one or more apparatuses to perform a method in accordance with any one of Clauses 1-47.

Clause 49: One or more apparatuses configured for wireless communications, comprising: one or more memories; and one or more processors, coupled to the one or more memories, configured to cause the one or more apparatuses to perform a method in accordance with any one of Clauses 1-47.

Clause 50: One or more apparatuses configured for wireless communications, comprising: one or more memories; and one or more processors, coupled to the one or more memories, configured to perform a method in accordance with any one of Clauses 1-47.

Clause 51: One or more apparatuses, comprising means for performing a method in accordance with any one of Clauses 1-47.

Clause 52: One or more non-transitory computer-readable media comprising executable instructions that, when executed by one or more processors of one or more apparatuses, cause the one or more apparatuses to perform a method in accordance with any one of Clauses 1-47.

Clause 53: One or more computer program products embodied on one or more computer-readable storage media comprising code for performing a method in accordance with any one of Clauses 1-47.

Clause 54: One or more apparatuses configured for wireless communications, comprising: a processing system that includes one or more processors and one or more memories coupled with the one or more processors, the processing system configured to cause the one or more apparatuses to perform a method in accordance with any one of Clauses 1-47.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE) to:
receive, in a set of time intervals, a broadcast or multicast transmission of a plurality of redundancy versions (RVs) of a transport block, the transport block comprising a plurality of code blocks (CBs), wherein a bit sequence of an RV of the plurality of RVs, in a time interval of the set of time intervals, is associated with a cyclic shift that is based on a number of the plurality of RVs; and
decode the plurality of CBs.

2. The apparatus of claim 1, wherein the cyclic shift is further based on at least one of a numerology of the broadcast or multicast transmission, or a quantity of CBs of the plurality of CBs.

3. The apparatus of claim 1, wherein the cyclic shift is consecutive across RVs of the plurality of RVs.

4. The apparatus of claim 1, wherein the cyclic shift is based on an RV index of a CB associated with the RV.

5. The apparatus of claim 1, wherein the cyclic shift is a function of a number of time intervals of the set of time intervals and a quantity of CBs of the plurality of CBs.

6. A method of wireless communication performed by a user equipment (UE), comprising:
receiving, in a set of time intervals, a broadcast or multicast transmission of plurality of redundancy versions (RVs) of a transport block, the transport block comprising a plurality of code blocks (CBs), wherein a bit sequence of an RV of the plurality of RVs, in a time interval of the set of time intervals, is associated with a cyclic shift that is based on a number of the plurality of RVs; and
decoding the plurality of CBs.

7. The method of claim 6, wherein the cyclic shift is further based on at least one of a numerology of the broadcast or multicast transmission, or a quantity of CBs of the plurality of CBs.

8. The method of claim 6, wherein the cyclic shift is consecutive across RVs of the plurality of RVs.

9. The method of claim 6, wherein the cyclic shift is based on an RV index of a CB associated with the RV.

10. The method of claim 6, wherein the cyclic shift is a function of a number of time intervals of the set of time intervals and a number of CBs of the plurality of CBs.

11. An apparatus for wireless communications, comprising:
means for receiving, in a set of time intervals, a broadcast or multicast transmission of plurality of redundancy versions (RVs) of a transport block, the transport block comprising a plurality of code blocks (CBs), wherein a bit sequence of an RV of the plurality of RVs, in a time interval of the set of time intervals, is associated with a cyclic shift that is based on a number of the plurality of RVs; and
means for decoding the plurality of CBs.

12. The apparatus of claim 11, wherein the cyclic shift is further based on at least one of a numerology of the broadcast or multicast transmission, or a quantity of CBs of the plurality of CBs.

13. The apparatus of claim 11, wherein the cyclic shift is consecutive across RVs of the plurality of RVs.

14. The apparatus of claim 11, wherein the cyclic shift is based on an RV index of a CB associated with the RV.

15. The apparatus of claim 11, wherein the cyclic shift is a function of a number of time intervals of the set of time intervals and a number of CBs of the plurality of CBs.
